(19) United States
(12) Patent Application Publication
(10) Pub. No.: US 2006/0068206 A1
(43) Pub. Date: Mar. 30, 2006

(54) Injection molding method for manufacturing plastic parts

(75) Inventors: Ralf Hala, Lindenberg (DE); Michael Kaisser, Trimmis (CH)

Correspondence Address: BROWDY AND NEIMARK, P.L.L.C.;624 NINTH STREET, NW, SUITE 300, WASHINGTON, DC, 20001-5303, US

(73) Assignee: EMS-CHEMIE AG, Domat/Ems (CH)

(21) Appl. No.: 11/234,301

(22) Filed: Sep. 26, 2005

Related U.S. Application Data
(60) Provisional application No. 60/612,639, filed on Sep. 24, 2004.

(30) Foreign Application Priority Data
Sep. 24, 2004 (CH) 2004 1563/04

(51) Int. Cl. B29C 45/16

(52) U.S. Cl. 428/411.1; 264/255; 264/328.8; 264/328.18

(57) ABSTRACT

Disclosed is an injection molding method for manufacturing plastic parts from thermoplastically processible plastic molding materials with at least one exposed part (1) and at least one functional part (10), whereby the plastic molding material for the exposed part (1) comprises a transparent or translucent matrix with added effect pigments, and whereby the functional parts (10) can exhibit different physical and/or chemical plastic properties to the exposed parts (1). The injection molding method comprises the following steps: a) injection molding and solidification of the plastic molding material of the at least one exposed part (1) with an exposed surface (2) and a core surface (3) facing away from the latter in a first mold (20) with a first cavity (21); b) opening of the first mold (20) along a parting line or plane (24); c) closing of a second mold (25) with the at least one exposed part (1) in a second cavity (28); d) injection molding and solidification of the plastic molding material of the functional part (10) on the core surface (3) of the at least one exposed part (1); and e) opening of the second mold (25) and removal of the part. The injection molding method according to the invention is characterized in that for each exposed part (1)—to prevent irregularities such as flow marks and/or knit lines—a single injection nozzle (5) positioned to optimize the flow or at least two injection nozzles in a cascaded injection molding method are used, and that the plastic molding material for the exposed part (1) comprises at least one transparent polymer. The corresponding plastic parts manufactured by injection molding exhibit an exposed surface (2) and a core surface (3) facing away from the latter with at least one injection point (6), whereby the functional part (10) of the plastic part is injection molded onto the core surface (3) of the previously solidified exposed part (1).

### RELATED APPLICATIONS

This patent application claims priority of the U.S. Provisional Application No. 60/612,639 and of the Swiss patent application No. CH 01563/04, both filed on 24, Sep. 2004. The whole content of these two priority applications is incorporated into the present application for all purposes by explicit reference.

### FIELD OF TECHNOLOGY

The subject of the invention, according to a first aspect and according to the generic term of independent claim 1, is an injection molding method for manufacturing plastic parts from thermoplastically processible plastic molding materials with at least one exposed part and at least one functional part, whereby the plastic molding material for the exposed part comprises a transparent or translucent matrix with added effect pigments, and whereby the functional parts can exhibit different physical and/or chemical plastic properties to the exposed parts. The subject of the invention, according to a second aspect and according to the generic term of independent claim 23, is plastic parts correspondingly manufactured from said plastic molding materials.

Said plastic parts are used in particular, but by no means exclusively, on automobiles, for example as enclosures for outside rear-view mirrors. For aesthetic reasons it is often necessary that said plastic parts be provided with a surface that, in its color and/or optical effect, matches the surface of an automobile. If it is a matter of surfaces that are to produce a metallic, interference, mother of pearl or opalescent effect, particularly high requirements are made of the layer that determines the surface. In addition, said parts are to exhibit a surface that is especially scratch-resistant and weatherable. Furthermore, said parts are to exhibit especially good mechanical properties, in particular high impact strength.

### RELATED PRIOR ART

Said plastic parts are usually manufactured in a multi-step process. First, parts are produced from a non-dyed plastic (e.g. by injection molding), and subsequently are varnished in the desired color (cf. EP 0 764 474). The function of the mechanically stressed core or functional part is assumed by the plastic, the exposed function or the desired optical effect is fulfilled by the varnish. Both materials can be selected appropriately to match their specific purpose. Before the actual varnishing operation, the plastic parts must be regularly pretreated (e.g. cleaned, degreased, ionized) so that the applied varnish will adhere properly. This familiar manufacturing process is thus cost consuming and also necessitates long throughput times. The process nevertheless produces optically faultless surfaces that are entirely free from irregularities in color distribution, such as demixing phenomena, dye agglomerations, flow marks, splay and poor distinctiveness of image.

An outside rear-view mirror for automobiles is known from DE 296 10 374 whose enclosure is manufactured from a pigmented thermoplastic. Although it is possible to achieve a match with the color of the automobile, and without the need for additional varnishing, such pigmented plastics are in most cases too expensive, and often exhibit flow marks on the exposed surfaces. Furthermore, the structure consisting of a single material forces the user into a compromise between good surface properties and good mechanical properties of the functional part with reinforcing ribs, attachment elements and the like.

A generic method for the injection molding of dual-component or triple-component parts is known from U.S. Pat. No. 6,468,458 that comprises the following steps for example: injection molding and solidification of the plastic molding material for an exposed part in a first mold with a first cavity; opening of the first mold along a parting line; closing of a second mold with the exposed part produced in the first mold in a second cavity; injection molding and solidification of the plastic molding material of a functional part on the core surface of the exposed part; opening of the second mold and removal of the part. DE 197 22 551 A1 and DE 100 01 010 A1 propose the manufacture of a multi-component part by a so-called “mono-sandwich” process. Such parts are produced by a multi-component injection molding method in a tool mold in that both components (skin and core component) are layered one after the other in a plastification unit and then injected into the mold in one injection operation. Here too, the two components can be selected appropriately to match them in as much as possible to their specific purpose. If effect colors are to be produced by including mother of pearl or metallic particles in the skin or surface component, such parts often tend to exhibit disturbing flow marks on their surface.

It is known from JP 2000 327 835, for example, that in particular flow marks and/or knit lines in injection molded effect layers are especially exposed and therefore found to be especially disturbing. Here one reads that flow marks and/or knit lines in an effect layer result from the fact that metal platelets, for example, adopt a non-random orientation because of the flow direction in the matrix surrounding them. If two melt fronts flow together, they remain exposed because of the different orientation of the metal platelets. Flow marks can be produced by locally differing flow velocities or flow directions in the effect layer. Knit lines can result from flow impediments in the effect layer. In any event, flow marks and/or knit lines detract from the optical impact of effect layers to a disturbing degree.

Others again (cf. e.g., U.S. Pat. No. 5,916,643) have tried to solve this problem of flow marks and/or knit lines by in-mold injection a deep-drawn film containing effect pigments. Depending on the required shape of the part and the effect color particles that are used, the elastic forming of the film can degrade the effects, with the result that striped patterns similar to flow marks become noticeable. Furthermore, the positioning of films in the injection mold—especially for undercut geometries—is often difficult; any edge can spoil the optical impression or must be removed or concealed.

### OBJECTS AND SUMMARY OF THE INVENTION

The object of the present invention is consequently to propose an alternative injection molding method whereby the excellent properties of different regions of the part are ensured.

This object is achieved according to a first aspect by the—characteristics of independent claim 1 in that an injection molding method, as mentioned initially, is proposed that comprises the following steps:
a) injection molding and solidification of the plastic molding material of the at least one exposed part with an exposed surface and a core surface facing away from the latter in a first mold with a first cavity that is defined by a first exposed mold half and a first core mold half;
b) opening of the first mold along a parting line or a parting plane by separating the first exposed mold half and the first core mold half from each other;
c) closing of a second mold with the at least one exposed part in a second cavity that is defined by a receptacle mold half with the exposed part and a second core mold half;
d) injection molding and solidification of the plastic molding material of the functional part on the core surface of the at least one exposed part to create a compound adhesion between the exposed part and the functional part; and
e) opening of the second mold and removal of the part.

The injection molding method proposed by the invention is characterized in that for each exposed part—to prevent irregularities such as flow marks and/or knit lines—a single injection nozzle positioned to optimize the flow or at least two injection nozzles in a cascaded injection molding method are used, and that the plastic molding material for the exposed part comprises at least one transparent polymer selected from a group of polymers that encompasses polyamides comprising aliphatic, cycloaliphatic and/or aromatic monomers, cyclic olefin copolymers, polymethyl methacrylate, polymethyl methacrylimide, polycarbonate and polycarbonate copolymers and their blends, polystyrene and acrylonitrile butadiene styrene polymerizates, styrene acrylonitrile, acrylonitrile styrene and other styrene copolymers and their blends, cellulose esters, polyimides and polyetherimides, polysulphones and polyethersulphones, polyphenylenes, polyacrylates and mixtures or blends of said polymers.

This object is achieved according to a second aspect by the characteristics of independent claim 23 in that a corresponding plastic part of thermoplastically processible plastic molding materials with at least one exposed part and at least one functional part is proposed, whereby the plastic molding material for the exposed part comprises a transparent or translucent matrix to which effect color particles or effect pigments are added, and whereby the functional part or parts can exhibit physical and/or chemical plastic properties different to those of the exposed part or parts. The plastic part proposed by the invention is characterized in that the exposed part or parts are manufactured by injection molding and exhibit an exposed surface and a core surface facing away from the latter with at least one injection point, whereby the functional part or parts of the plastic part are injection molded onto the core surface of the previously solidified exposed parts.

Especially preferred further embodiments of the method according to the invention or plastic part according to the invention and further inventive characteristics result from the related dependent claims.

### BRIEF INTRODUCTION OF THE FIGURES

The present invention is detailed more fully in what follows with reference to schematic figures that are intended to explain the scope of the invention but not to confine it. Said figures show:

FIG. 1 a section through a closed first injection molding mold with a first cavity that is defined by a first or common exposed mold half and a first core mold half.

FIG. 2 a section through a closed second injection molding mold with a second cavity that is defined by a receptacle mold half or a common exposed mold half with the exposed part and a second core mold half.

### DETAILED DESCRIPTION OF THE INVENTION

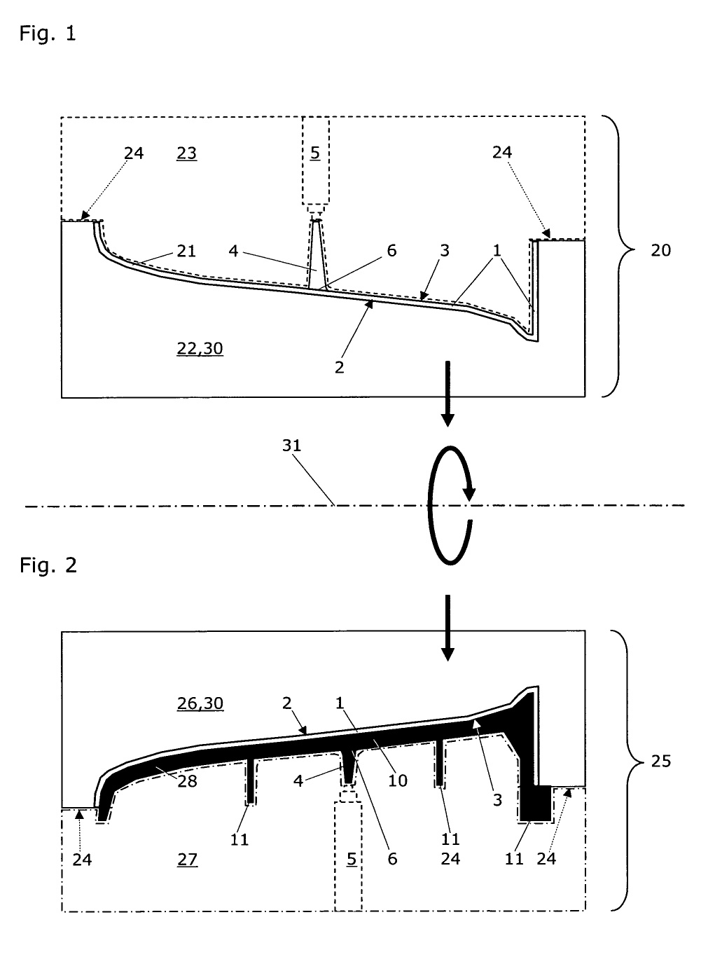

FIG. 1 shows a section through a closed first injection molding mold to execute the first step of the injection molding method according to the invention for manufacturing plastic parts from thermoplastically processible plastic molding materials.

Said molding materials, known per se from the prior art, are processed into a plastic part that comprises at least one exposed part 1 and at least one functional part 10, whereby the plastic molding material for the exposed part 1 comprises a transparent or translucent matrix with added effect pigments. The effect dye particles or effect pigments are premixed as a color concentrate, for example, and dosed as a master batch or liquid dispersion into the feeder of an injection molding screw. Alternatively, before injection molding (e.g. by compounding), an appropriate plastic granulate is produced and applied to the injection molding machine. The functional parts 10 can exhibit physical and/or chemical plastic properties different to those of the exposed parts 1. The exposed part(s) 1 and functional part(s) 10 may also exhibit an identical polymer matrix however.

Essential characteristics of an exposed part 1 comprise the following aspects:

High resistance to ultraviolet radiation, heat, light, dampness, cold and chemicals; high scratch resistance, high impact strength and high gloss. The effect pigments, if distributed in such a matrix, generate a metallic or interference effect, e.g. a mother of pearl effect. The more translucent or transparent this matrix, the more marked is the color effect, in particular a glistening of the individual effect particles. The penetration of the effect pigments depends on the transparency of the matrix. However, imperfectly transparent or translucent matrix materials may also be used. Optionally, other dyes can be added to the plastic molding material for the exposed part 1 so that, for example, any transparent color shade matched to the effect pigments can be produced.

In the context of the present invention, effect pigments are defined as insoluble particles existing in a polymer matrix. Such effect pigments reflect or absorb incident electromagnetic waves (in particular in the exposed wavelength region, in the UV or IR or NIR region), or influence said waves in some manner or another. Thus, for example, NIR-sensitive additives can be used in laser welding or laser inscription of plastics.

Metal particles, aluminum/bronze powder, interference pigments, natural (non-dyed) and color varnished aluminum flakes and mineral mica are known as effect pigments, for example, especially for use in transparent plastics (see Schäfer/Küsters in chapter 1.3: Rohstoffe für Masterbatches, in FARB-UND ADDITIV-MASTERBATCHES IN DER PRAXIS, published by Masterbatch Verband im Verband der Mineralfarbenindustrie e.V., Frankfurt/Main, Germany, 2003). These authors also point to the appearance of flow marks and/or knit lines in the use of extremely fine pearlescent effect pigments. Aluminum and gold bronze pigments, for example, are obtainable under the trade name PHOENIX® (ECKART GmbH & Co. KG, Fürth, Germany).

Ceramic effect colors, aromatic colors, fluorescent colors, daylight fluorescent colors, infrared fluorescent colors, photoreactive colors that alter their shade in UV radiation, and thermionic colors that alter their shade in a changing temperature are marketed under the trade name COLORLINE® (COLORTEK Farbsysteme GmbH, Karstädt, Germany) and can be used as effect pigments or added to effect pigments as required.

Furthermore, pearlescent pigments or mother of pearl particles are known that can be used for the same purpose in the exposed part 1; in such cases a dark shading of the functional part 10 is preferred. Especially preferred are metallic pigments, in particular aluminum flakes (cf. EP 0 994 915) or mother of pearl particles. Any mixtures of these effect particles are also possible. The effect particles are preferably premixed as a color concentrate, and dosed as a master batch or liquid dispersion into the feeder of an injection molding screw (not shown).

The plastic molding material for the exposed part 1 preferably comprises at least one transparent polymer selected from a group of polymers that encompasses polyamides comprising aliphatic, cycloaliphatic and/or aromatic monomers, such as PA MACM 12, PA PACM 12 (cf. the published patent application JP 11 279 289); COC (cyclic olefin copolymers); PMMA (polymethyl methacrylate); PMMI (polymethyl methacrylimide); PC (polycarbonate) and polycarbonate copolymers and their blends; PS (polystyrene) and ABS (acrylonitrile butadiene styrene polymerizates); SAN (styrene acrylonitrile); ASA (acrylonitrile styrene) and other styrene copolymers and their blends; cellulose esters such as CA, CP and CAB; PI (polyimides) and PEI (polyetherimides); polysulphones and polyethersulphones (PES, PSU, PPSU); polyphenylenes (PPO, PPE); polyacrylates (PAR) and mixtures or blends of these polymers.

Transparent polyamides that are known per se (and that may also exist in the form of copolyamides) are also preferably used for the molding materials according to the invention and for the method according to the invention, produced from monomers selected from the following group for example:
branched or un-branched aliphatic diamines with 6 to 14 C-atoms, e.g. 1,6-hexamethylene diamine, 2-methyl-1,5-diaminopentane, 2,2,4-trimethylhexamethylene diamine, 1,9-nonamethylene diamine, 1,10-decamethylene diamine, or 1,12-dodecamethylene diamine;
cycloaliphatic diamines with 6 to 22 C-atoms, e.g. 4,4′-diaminodicyclohexylmethane, 3,3′-dimethyl-4,4′-diaminodicyclohexylmethane, 4,4′-diaminodicyclohexylpropane, 1,4-diaminocyclohexane, 1,4-bis(aminomethyl)cyclohexane, 2,6-bis(aminomethyl)norbornane or 3-aminomethyl-3,5,5-trimethylcyclohexylamine;
araliphatic diamines with 8 to 22 C-atoms, e.g. m- or p-xylylene diamine or bis(4-aminophenyl)propane;
branched or un-branched aliphatic dicarboxylic acids with 6 to 22 C-atoms, e.g. adipic acid, 2,2,4- or 2,4,4-trimethyladipic acid, azelaic acid, sebacic acid or 1,12-dodecanic acid;
cycloaliphatic dicarboxylic acids with 6 to 22 C-atoms, e.g. cyclohexane-1,4-dicarboxylic acid, 4,4′-dicarboxyldicyclohexylmethane, 3,3′-dimethyl-4,4′-dicarboxyldicyclohexylmethane, 4,4′-dicarboxyldicyclohexylpropane and 1,4-bis(carboxymethyl)cyclohexane;
araliphatic dicarboxylic acids with 8 to 22 C-atoms, e.g. 4,4′-diphenylmethane dicarboxylic acid;
aromatic dicarboxylic acids with 8 to 22 C-atoms, e.g. isophthalic acid, tributylisophthalic acid, terephthalic acid, 1,4-, 1,5-, 2,6- or 2,7-naphthalenedicarboxylic acid, diphenic acid or diphenylether-4,4′-dicarboxylic acid;
lactams with 6 to 12 C-atoms or the corresponding ω-aminocarbonic acids, e.g. ε-caprolactam, ε-aminocaproic acid, capryllactam, ω-aminocaprylic acid, ω-aminoundecanoic acid, lauric lactam or ω-aminododecanoic acid.

Especially preferred are transparent homopolyamides such as PA MACM 12 und PA PACM 12, the transparent copolyamides PA 12/MACMI and PA MACM/PACM 12, as well as mixtures or blends of the same. Of very special preference is PA MACM/PACM 12, which is known from EP 1 369 447.

Translucent or even transparent exposed parts 1 according to the invention can also be manufactured from partly crystalline polymers such as polypropylene, saturated linear polyesters (e.g. PET) and linear aliphatic polyamides (e.g. PA 6, PA 66, mixtures of PA 6 and PA 66, PA 11, PA 12) in suitable process and cooling conditions and/or by producing suitable layer thicknesses.

Conventional additives such as plasticizers, anti-static agents, flame retardants, fillers, dyestuffs, aromatic dyes or aromatic substances, stabilizers (e.g. heat and UV stabilizers and/or UV absorbers) and pigments are mixed with the plastic molding material for the exposed part 1 as required. Also possible are reinforcing means such as glass fibers, glass spheres and mineral admixtures (in particular nanoscale minerals or nanocomposites) as long as they do not detract from the optical impression of the exposed part 1.

FIG. 2 shows a section through a closed second injection molding mold with a second cavity that is defined by a receptacle mold half or a common exposed mold half with the exposed part and a second core mold half.

Essential characteristics of a functional part 10 comprise the following aspects:

High impact strength, mechanical rigidity and dimensional stability; good compatibility with the plastic molding material of the exposed part 1. Adequate mechanical strength, excellent creep strength, high thermal stability. Electrical characteristics are possibly also to be considered.

Suitable for manufacturing the functional part 10 are injection-moldable thermoplasts from the group of polyamides, polyesters, polyolefins, polycarbonates or thermoplastic elastomers such as TPU (thermoplastic polyurethane), styrene block copolymers such as SEBS (styrene ethylene butadiene styrene), SBS (styrene butadiene styrene), polyester elastomers, polyether elastomers, polyether ester elastomers (TEEE); silicones that are subsequently cross-linked; ABS (acrylonitrile butadiene styrene polymerizates) or PVC. Thermoplastic elastomers are used in particular when the functional part 10 is a seal. It is also possible to manufacture the functional part 10 from blends or the recycling products of the aforementioned polymers or from their blends that are compatible or made compatible.

Conventional additives such as impact strength modifiers, stabilizers (e.g. UV and heat stabilizers), plasticizers, dyestuffs, flame retardants, fillers, reinforcing means (e.g. glass fibers, carbon fibers, mica, glass spheres) and/or pigments are mixed with the plastic molding material for the functional part 10 as required.

Once the material for the exposed part 1 has been specified, and with a view to good compound adhesion, a material is preferably selected for the functional part 10 that belongs to the same polymer class, or that is even identical to the polymer of the exposed part 1. If, for example, PA MACM 12 (obtainable from EMS-Chemie AG, Domat/Ems, Switzerland, under the brand name Grilamid® TR 90) is selected for the exposed part 1, then, with a view to good compound adhesion in manufacture of the functional part 10, a PA MACM 12 GF 40 (molding material of Grilamid® TR 90 with 40% glass fiber share) is preferably used for instance (obtainable under the brand name Grilamid® TRV-4×9 from EMS-Chemie AG, Domat/Ems, Switzerland).

Alternatively, with the aforementioned exposed part 1 of Grilamid® TR 90, a different polymer can be used as a plastic molding material for the functional part 10, namely a glass sphere reinforced polyamide 12, e.g. a PA 12 GK 50 (molding material of polyamide 12 with 50% glass sphere share). Also suitable as a plastic molding material for the functional part 10 are blends in which at least one of the blend components is responsible for compound adhesion with the exposed part 1. This blend component is preferably identical to a polymer component of the exposed part 1.

If the exposed part 1 and the functional part 10 should be wholly or partly incompatible with one another, i.e. create a, by nature, inadequate compound adhesion, their compatibility can be enhanced by adhesion modifiers such as polyolefins with reactive groups (cf. EP 0 393 409 B1) that are added to the molding material of the functional part 10 and/or the molding material of the exposed part 1.

The injection molding method according to the invention for manufacturing plastic parts from thermoplastically processible plastic molding materials with at least one exposed part 1 and at least one functional part 10, whereby the plastic molding material for the exposed part 1 comprises a transparent or translucent matrix with added effect pigments, and whereby the functional parts 10 can exhibit different physical and/or chemical plastic properties to the exposed parts 1, comprises the ready defined steps a) through e) and is characterized in that for each exposed part 1—to prevent irregularities such as flow marks and/or knit lines—a single injection nozzle 5 positioned to optimize the flow or at least two injection nozzles in a cascaded injection molding method are used, and that the plastic molding material for the exposed part 1 comprises at least one transparent polymer selected from a group of polymers that encompasses polyamides comprising aliphatic, cycloaliphatic and/or aromatic monomers, cyclic olefin copolymers, polymethyl methacrylate, polymethyl methacrylimide, polycarbonate and polycarbonate copolymers and their blends, polystyrene and acrylonitrile butadiene styrene polymerizates, styrene acrylonitrile, acrylonitrile styrene and other styrene copolymers and their blends, cellulose esters, polyimides and polyetherimides, polysulphones and polyethersulphones, polyphenylenes, polyacrylates and mixtures or blends of said polymers.

The first exposed mold half 22 is preferably identical to the receptacle mold half 26, and is used as a common exposed mold half 30 for both injection molding operations according to steps a) and d). After the first injection molding operation according to step a), the exposed part 1 is left in this common exposed mold half (30). One of a number of preferred apparatuses for performing this method is disclosed in EP 0 895 848 B1 (cf. FIG. 1 therein). The subject is an apparatus for manufacturing injection molded articles from at least two plastic melts. Arranged between two mold halves 34,35 installed on a machine frame there is a mold mounting plate with preferably at least two mold halves that is pivotable about a rotary axis aligned perpendicular to the longitudinal axis of the tie rods of this machine frame. The two non-pivotable mold halves 34,35 take the form of core mold halves, and exhibit all necessary ports and at least one injection molding screw each or at least one sprue channel each. One of these non-pivotable core mold halves is also stationary, while the other injection mold half can be shifted along the tie rods to close the mold stack. Although only lost core injection molding is disclosed in EP 0 895 848 B1, the apparatus described here is nevertheless also suitable for the method proposed by the present invention: the mold mounting plate pivotable about a rotary axis, as disclosed in EP 0 895 848 B1, is preferably fitted with at least two first exposed mold halves 22 that are then rotated or pivoted about an axis 31 as the common exposed mold halves 30,30′,30″, etc. between the steps a) and d). This rotary axis 31 is essentially parallel to the parting line or parting plane 24 of the two mold halves 22,26,30 and 23,27 and would thus be arranged horizontally between FIGS. 1 and 2.

It is thus obvious that the exposed part 1 with an exposed surface 2 and a core surface 3 facing away from the latter is injection molded in step a) and allowed to solidify. This is performed in a first cavity 21 (see FIG. 1) that is defined by a first exposed mold half 22 (solid line) and a first core mold half 23 (dashed line). For this step a) the following arrangements of the two mold halves consequently result—depending on spatial orientation:

$$\begin{matrix}( 23 ) ( 22 ) & or & ( 22 ) ( 23 ) & or & ( 23 ) & or & ( 22 ) \\ & & & & ( 22 ) & & ( 23 )\end{matrix}$$

The preferred arrangement selected in FIG. 1, in which the exposed mold half 22 is below and the core mold half 23 above it, is marked here in bold print. Of course, the mold halves 22,23 can assume any other position differing from the perpendicular or horizontal.

The exposed part 1 is preferably manufactured with an essentially uniform layer thickness. This can be done—depending on the geometry of the exposed part 1 to be molded—by using just one injection nozzle 5, which must always be arranged on the side facing away from the exposed surface 2 however. If only a single injection nozzle 5 is used, an essential advantage of the method according to the invention comes to bear: the position of the gate or injection point 6 can be optimized in terms of even flow and filling of the cavity so that no irregularities such as flow marks and/or knit lines result. This gate or injection point 6 can thus be placed in the middle of a part that is awkward per se and clearly exposed on the finished plastic part: the evenly flowing filling of the cavity allows uniform distribution of the plastic molding material with the added effect particles with the result that this gate or injection point 6 leaves no vestige on the finished part. Furthermore, the essentially uniform thickness of the exposed part 1 produces a homogeneous optical impression and uniform color depth and opacity. This opacity can be increased by dying the functional material bearing the exposed part 1.

Alternatively, especially with disadvantageous flow path/wall thickness ratios or part geometries, at least two injection nozzles 5 can be used in a cascaded injection molding method (not shown). Here it is important to ensure that all injection nozzles 5 are arranged on the side facing away from the exposed surface 2, and that injection commences through only one nozzle 5 and continues until the melt front has passed at least one more gate or injection point 6. Every further gate 6, once this situation is achieved, can then be put into operation and the exposed part 1 ready molded.

Subsequently, in step b), this first mold 20 is opened along a parting plane or parting line 24 by moving (direction of arrow in FIG. 1) the first exposed mold half 22 away from the first core mold half 23. This parting line or parting plane 24 is preferably essentially at right angles to the tie bars of the machine frame. In FIG. 1 this parting line or parting plane 24 is essentially horizontal, i.e. at right angles to the vertical movement of the first exposed mold half 22.

Following this, in step c), a second mold 25 with a second cavity 28 containing the exposed part 1 is closed (cf. arrow in FIG. 2), this second cavity 28 being defined by a receptacle mold half 26 with the exposed part 1 and a second core mold half 27. Corresponding to the teaching in EP 0 895 848 B1, the first exposed mold half 22 is rotated about the horizontal axis 31 (cf. arrow about axis 31 in FIG. 1) and now corresponds to the receptacle mold half 26. The first exposed mold half 22 and the receptacle mold half 26 can thus be termed a common exposed mold half 30. Preferably at least two common exposed mold halves 30,30′ are used next to one another and/or opposite to increase the productivity of the injection molding plant. But it is also possible to provide three, four or more common exposed mold halves 30,30′,30″,30′″, etc. In addition, the middle pivotable part can be turned or pivoted respectively for the next step of the process by only an increment of 360°, e.g. by 180°, 90° or 45° (cf. EP 0 249 703 B1) or 600, etc. In use of the common exposed mold halves 30,30′ the cooled exposed part 1 can be left in the first exposed mold half 22 after step a).

As an alternative to this step, the cooled exposed part 1 can be removed from the first exposed mold half 22 and placed in the receptacle mold half 26 of the same or a further injection molding machine. This can be done automatically, by a robot for example, or manually. Removal from the first exposed mold half 22 and insertion in the receptacle mold half 26 is preferably executed by gripping at least one boss 4 left on the exposed part 1. The exposed part 1, when it is inserted in the receptacle mold half 26, is preferably centered by means of at least one boss 4 left on the exposed part 1. The receptacle mold half 26 preferably exhibits a contour that is matched to the exposed part 1. If hot runner apparatus is used, these bosses 4 may not be produced, meaning that in such cases other removal and centering means will be necessary.

In step d) the functional part 10 is injection molded on the core surface 3 of the exposed part 1 to create a compound adhesion between the exposed part 1 and the functional part 10 and allowed to solidify. For this step d) there are thus (according to EP 0 895 848 B1 and using two common exposed mold halves 30)depending on the spatial orientation and mode of execution of the method—the following arrangements of the mold halves:

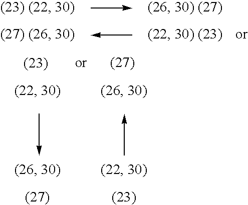

According to the alternative in which the exposed part 1 is turned from a first exposed mold half 22 into a receptacle mold half 26, the corresponding arrangements are thus:

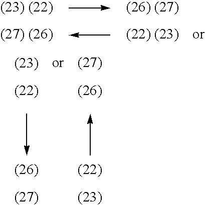

The arrangement chosen in FIGS. 1 and 2 is marked here in bold print. Of course, the mold halves 22,23,30 can assume any other position differing from the perpendicular or horizontal.

Finally, in a last step e), the second mold 25 is opened and the part is ejected.

A further alternative injection molding method comprises the pivoting of a common exposed mold half 30 about an axis perpendicular to the parting line or parting plane 24. Multiple common exposed mold halves 30,30′,30″, etc can be arranged on an appropriate pivot platform (not shown) that are then each pivoted in front of a second core mold half 27,27′,27″, etc to define a second injection molding mold 25,25′,25″, etc. Preferably, here too, the cooled exposed part 1 is left in the common exposed mold half 30,30′,30″, etc after step a) and is in-mold injected with the plastic molding material for the functional part 10 in step d). Depending on the number of components, two, three or more common exposed mold halves 30,30′,30″, etc can be positioned on a turntable that must then be rotated appropriately by 180°, 120° or 90°, for example, after each injection molding operation. Depending on the machine configuration, said turntable can be oriented horizontally, vertically or at another angle, but the rotary axis is in any case essentially at right angles to the turntable. The common exposed mold halves 30,30′,30″, etc can be rotated, pivoted or shifted about or along an axis 31 on their way between the stations for the first and second injection molding operation. This shift can be linear or in a direction differing from this, e.g. following a curve.

Generally it is preferred that the effect dye particles or effect pigments be premixed as a color concentrate and dosed as a master batch or liquid dispersion into the feeder of an injection molding screw. Alternatively it is preferred that an appropriate plastic granulate be produced by compounding before injection molding and used in this form on the injection molding machine. The injection molding method according to the invention can be used to manufacture very different plastic parts. Common to all plastic parts manufactured by the injection molding method according to the invention is that they exhibit one or more exposed surfaces 2 with high gloss and comprising at least one exposed part 1 with embedded or added effect pigments.

The method according to the invention is equally suitable for manufacturing any multicoated plastic parts that are to exhibit an exposed surface 2 of high optical quality. These include matt, satined and glossy surfaces.

The method according to the invention can be used to manufacture molded parts that comprise an effect layer with effect pigments as an exposed part 1, these including, within the scope of the present invention, embedded decorative means such as colored plastic granulates, color pigments, color platelets, color strips, metal powder, metal flakes, colored glass spheres, ceramic substances, fiber-like substances and the like.

The following is an exemplary listing, by no means conclusive, of preferred products that can be manufactured by the method according to the invention:
Enclosures, enclosure parts and other parts of electrical, electronic, telecommunications, security, medical, domestic or personal hygiene apparatus. Such apparatus includes, for example, cameras, coffee machines, cellular telephones and their rests; razors; power switches; radios, television sets computers as well as their accessories, keyboards and monitors; mixers and hair-driers.
Sport and leisure equipment, fashion accessories, toys or parts of the same, e.g. skis, ski bindings, snowboards, surfboards, ski helmets, bicycle and motorcycle helmets, tennis rackets.
Design elements to be attached internally or externally on buildings, traffic routes or vehicles (e.g. bicycles, motorcycles, automobiles and rail vehicles, ships and aircraft) such as ceiling panels, kitchen covers and enclosures, mirror frames, trim parts, luminaria, decorative strips and decorative caps; glazing (e.g. automobile windows), wheel covers, acoustic and reflective shells, screens, B-column cladding for automobiles, door handles, handle recesses, spoilers, antennas, windshield wiper arms, fluorescent breakdown warning triangles and other traffic signals or signal panels; number plates fluorescing in white light or infrared light; various household items such as handles and fittings of very kind, e.g. door and window handles, coat hooks and clotheshangers; sanitary fittings and apparatus as well as sanitary articles such as water tap handles, soap dishes, toilet fixtures and the like.
Optical aids such as eyeglass lenses with photoreactive colors, optical filters, spectacle frames, sunglass disks; shields and visors for eye protection (e.g. on helmets); injection molded glazing of every kind.
Furniture and furniture parts such as tables, chairs, arm rests and tabletops; packaging parts such as lids or caps of cans and bottles (e.g. for beverages or perfume), aerosols or tubes, as well as the cans or tubes themselves.

A special characteristic of the plastic parts manufactured according to the invention is, as already stated, the fact that the exposed part 1 is manufactured by injection molding and exhibits an exposed surface 2 and a core surface 3 facing away from it with at least one gate or injection point 6, whereby the functional part 10 of the plastic part is injection molded onto the core surface 3 of the previously solidified exposed part 1. All plastic parts manufactured according to the invention consequently exhibit an exposed part 1 with essentially uniform layer thickness, whereby the reverse side of the exposed part 1 exhibits a gate or injection point 6. This gate can take the form of a boss 4 that can be molded over or around in the second injection molding operation for the functional part 10. In the use of common exposed mold halves 30 it is also possible not to form this boss 4 or to separate it before the following injection molding step.

Functional parts 10 are characterized in that they exhibit functional elements 11 in the form of attachment elements, e.g. threads, snap-on hooks, springs, pins or spacers such as nobs or bosses. They can also comprise reinforcing elements such as ribs or grids and/or sealing elements such as lip seals. Functional parts 10 also comprise undercuts and breakthroughs. In most cases neither functional parts 10 nor functional elements 11 are exposed or visible in the end-product.

Special functional elements 11, preferably arranged on the reverse of a functional part 10, are vibration influencing masses that shift the resonant frequency of the overall plastic parts consisting of exposed parts 1 and functional parts 10 or damp it where the amplitude of vibration is highest. The vibration response of such plastic parts can be simulated as early as the design phase on a computer and in this way is optimized. This applies, for example, to automobile cowling such as fenders, engine hoods, retractable roofs, sunroofs, trunk lids and the like that are subject to dynamic stress in use through vibration and/or the air stream, and respond differently to automobile parts of another material such as metal.

Functional elements 11 of plastic can also comprise metal parts such as threaded bolts or springs that are inserted in the second injection molding mold 25 before the injection molding operation, or are inserted in the functional part 10 after injection molding.

Basically the plastic parts according to the invention can exhibit one or more exposed parts 1 and can be composed of two or more components. Such parts can comprise one or more functional parts 10. In addition, further elements such as cushions, seals and insulating mats can be attached or arranged, in particular foamed, vulcanized or injection molded, on the functional parts 10, in particular on the side facing away from the exposed part 1.

Use of the injection molding method according to the invention has shown that plastic parts can be manufactured with high-gloss surfaces in the exposed part 1 that—as a result of the added effect pigments—produce a metallic, interference, mother of pearl or opalescent effect and that are free from demixing phenomena, dye agglomerations, flow marks, knit lines, splay, poor distinctiveness of image and joint lines.

The method according to the invention can also be applied to in-mold pressing, which, as is known, is a special form of the injection molding process. Through the use of in-mold pressing it is possible to further improve the surface quality and the replication accuracy of the exposed part 1 in the injection molding of plastic parts according to the invention.

1. An injection molding method for manufacturing plastic parts from thermoplastically processible plastic molding materials with at least one exposed part and at least one functional part, whereby the plastic molding material for the exposed part comprises a transparent or translucent matrix with added effect pigments, the functional parts can exhibit different physical and/or chemical plastic properties to the exposed parts, and whereby the injection molding method comprises the following steps:
a) injection molding and solidification of the plastic molding material of the at least one exposed part with an exposed surface and a core surface facing away from the latter in a first mold with a first cavity that is defined by a first exposed mold half and a first core mold half;
b) opening of the first mold along a parting line by moving the first exposed mold half away from the first core mold half;
c) closing of a second mold with the at least one exposed part in a second cavity that is defined by a receptacle mold half with the exposed part and a second core mold half;
d) injection molding and solidification of the plastic molding material of the functional part on the core surface of the at least one exposed part to create a compound adhesion between the exposed part and the functional part; and
e) opening of the second mold and removal of the part, wherein for each exposed part—to prevent irregularities such as flow marks and/or knit lines—a single injection nozzle positioned to optimize the flow or at least two injection nozzles in a cascaded injection molding method are used, and wherein the plastic molding material for the exposed part comprises at least one transparent polymer selected from a group of polymers that encompasses polyamides comprising aliphatic, cycloaliphatic and/or aromatic monomers, cyclic olefin copolymers, polymethyl methacrylate, polymethyl methacrylimide, polycarbonate and polycarbonate copolymers and their blends, polystyrene and acrylonitrile butadiene styrene polymerizates, styrene acrylonitrile, acrylonitrile styrene and other styrene copolymers and their blends, cellulose esters, polyimides and polyetherimides, polysulphones and polyethersulphones, polyphenylenes, polyacrylates and mixtures or blends of said polymers.

2. The injection molding method according to claim 1,
wherein the first exposed mold half is identical to the receptacle mold half and is used as a common exposed mold half for both injection molding operations according to steps a) and d), whereby the exposed part remains in this common exposed mold half after the first injection molding operation according to step a).

3. The injection molding method according to claim 2,
wherein the common exposed mold half, between steps a) and d), is rotated, pivoted or shifted about or along an axis that is essentially either parallel or perpendicular to the parting plane of the two mold halves.

4. The injection molding method according to claim 1,
wherein the receptacle mold half is different to the first exposed mold half, whereby the exposed part is removed from the first exposed mold half after the first injection molding operation according to step a) and inserted in the receptacle mold half for the second injection molding operation according to step d).

5. The injection molding method according to claim 4,
wherein removal from the first exposed mold half and insertion in the receptacle mold half is executed by gripping at least one boss left on the exposed part.

6. The injection molding method according to claim 4,
wherein the exposed part is centered by means of at least one boss left on the exposed part when it is inserted in the receptacle mold half.

7. The injection molding method according to claim 1,
wherein the exposed part is manufactured with an essentially uniform layer thickness.

8. The injection molding method according to claim 1,
wherein the effect pigments are premixed as a color concentrate and dosed as a master batch or liquid dispersion into the feeder of an injection molding screw or wherein an appropriate plastic granulate is produced by compounding and used in this form on the injection molding machine.

9. The injection molding method according to claim 1,
wherein the effect pigments are selected from a group that comprises metallic pigments—in particular non-dyed or dyed aluminum flakes or aluminum or gold bronze pigments—, interference pigments, pearlescent pigments, mineral mica and mixtures thereof.

10. The injection molding method according to claim 9,
wherein the metallic pigments are selected from a group that comprises non-dyed and color varnished aluminum flakes and aluminum and gold bronze pigments.

11. The injection molding method according to claim 1,
wherein the plastic molding material for the exposed part comprises at least one transparent polymer selected from a group of polymers that comprises polyamides or copolyamides, their mixtures or blends and that is produced from monomers selected from the following group:
branched or un-branched aliphatic diamines with 6 to 14 C-atoms;
cycloaliphatic diamines with 6 to 22 C-atoms;
araliphatic diamines with 8 to 22 C-atoms;
branched or un-branched aliphatic dicarboxylic acids with 6 to 22 C-atoms;
cycloaliphatic dicarboxylic acids with 6 to 22 C-atoms;
araliphatic dicarboxylic acids with 8 to 22 C-atoms;
aromatic dicarboxylic acids with 8 to 22 C-atoms;
lactams with 6 to 12 C-atoms or the corresponding ω-aminocarbonic acids.

12. The injection molding method according to claim 1,
wherein the plastic molding material for the exposed part comprises at least one transparent polymer selected from a group of polymers that comprises PA MACM 12, PA PACM 12, PA 12/MACMI, and PA MACM/PACM 12 as well as blends of the same.

13. The injection molding method according to claim 1,
wherein at least one additive, selected from the group of UV stabilizers, UV absorbers and their mixtures, is added to the plastic molding material for the exposed part.

14. The injection molding method according to claim 1,
wherein in-mold pressing is used in injection molding of the exposed part.

15. The injection molding method according to claim 1,
wherein the plastic molding material for the functional part comprises at least one injection-moldable polymer selected from a group of polymers that comprises polyamides, polyesters, polyolefins, polycarbonates, thermoplastic elastomers, styrene block copolymers, silicones, acrylonitrile butadiene styrene polymerizates, PVC as well as their blends or recycling products.

16. The injection molding method according to claim 15,
wherein the plastic molding material for the functional part comprises at least one injection-moldable polymer selected from said group of polymers or a blend, in which at least one of the blend components is responsible for compound adhesion with the exposed part.

17. The injection molding method according to claim 15,
wherein the plastic molding material for the functional part comprises a polymer that is identical to a polymer contained in the molding material for the exposed part.

18. The injection molding method according to claim 1,
wherein an adhesion modifier is added to the plastic molding material for the functional part and/or the molding material for the exposed part to improve compound adhesion between the functional part and the exposed part.

19. The injection molding method according to claim 1 to manufacture enclosures, enclosure parts and/or other parts of electrical, electronic, telecommunications, security, medical, domestic or personal hygiene apparatuses.

20. The injection molding method according to claim 1 to manufacture sport and/or leisure equipment, fashion accessories, toys or parts of the same.

21. The injection molding method according to one of the claims 1 through 18 claim 1 to manufacture design and/or paneling elements for buildings, traffic routes or vehicles.

22. The injection molding method according to claim 1 to manufacture optical aids, glazing, furniture and/or packaging parts.

23. A plastic part, in particular manufactured according to the injection molding method of claim 1, of thermoplastically processible plastic molding materials with at least one exposed part and at least one functional part, whereby the plastic molding material for the exposed part comprises a transparent or translucent matrix with added effect pigments, and whereby the functional parts can exhibit different physical and/or chemical plastic properties to the exposed parts,
wherein the exposed parts are manufactured by injection molding and exhibit an exposed surface and a core surface facing away from the latter with at least one injection point, whereby the functional parts of the plastic part are injection molded onto the core surface of the previously solidified exposed parts.

24. The plastic part according to claim 23,
wherein the exposed part exhibits an essentially uniform layer thickness.

25. The plastic part according to claim 23,
wherein the plastic molding material for the exposed part comprises at least one transparent polymer selected from a group of polymers that comprises PA MACM 12, PA PACM 12, PA 12/MACMI, PA MACM/PACM 12, COC, PMMA, PMMI, PC, PS, ABS, SAN, ASA, cellulose ester, PI, PEI, polysulphones, polyethersulphones, polyphenylenes, polyacrylates and mixtures or blends of these polymers.

26. The plastic part according to claim 25,
wherein the plastic molding material for the functional part comprises at least one injection-moldable polymer selected from a group of polymers that comprises said group of polymers for the exposed part as well as polyamides, polyesters, polyolefins or polycarbonates, thermoplastic elastomers, styrene block copolymers, silicones, acrylonitrile butadiene styrene polymerizates, PVC and their blends or recycling products.

27. The plastic part according to claim 23,
wherein the functional part comprises functional elements that are selected from a group comprising attachment elements, masses to influence vibration, reinforcing elements, sealing elements and spacers.

28. The plastic part according to claim 23,
which is a unit, enclosure, toy, fashion accessory, design or paneling element, optical aid, item of furniture, glazing or packaging or part thereof.
